(19) United States
(12) Patent Application Publication
(10) Pub. No.: US 2015/0155001 A1
(43) Pub. Date: Jun. 4, 2015

(54) ELECTRONIC APPARATUS AND RECORDING FILE TRANSMISSION METHOD

(71) Applicant: Kabushiki Kaisha Toshiba, Tokyo (JP)

(72) Inventors: Yusaku Kikugawa, Ome Tokyo (JP); Masataka Osada, Kawasaki Kanagawa (JP); Kentaro Takeda, Tokyo (JP)

(21) Appl. No.: 14/535,158

(22) Filed: Nov. 6, 2014

(30) Foreign Application Priority Data
Nov. 29, 2013 (JP) 2013-248153

(51) Int. Cl. G11B 20/10; G10L 25/93

(52) U.S. Cl. CPC G11B 20/10527; G10L 25/93

(57) ABSTRACT

According to one embodiment, an electronic apparatus includes a memory and a processor. Each of files comprises positional information and time information. The files are prepared by apparatuses. The processing circuitry searches from files comprising a first file, for a second file corresponding to the first file based on the positional information and the time information associated with each of the files, determines whether recorded content of the second file comprises a part of recorded content of the first file, and transmits a third file comprising a part of the second file to a first apparatus when the recorded content of the second file comprises a part of the recorded content of the first file.

### CROSS-REFERENCE TO RELATED APPLICATIONS

This application is based upon and claims the benefit of priority from Japanese Patent Application No. 2013-248153, filed Nov. 29, 2013, the entire contents of which are incorporated herein by reference.

### FIELD

Embodiments described herein relate generally to an electronic apparatus comprising a plurality of recording files and a recording file transmission method.

### BACKGROUND

Recently, digital voice recorders which store (record) a recoding file in a nonvolatile memory such as a flash memory have become widespread. There is a case where voice cannot be continuously recorded because the battery runs down or because of the nonvolatile memory shortage, etc. In such a case, the takeover of the voice recording by another recorder is suggested.

In order to realize the takeover of the voice recording by another recorder, the mutual registration between the recorders is necessary when the recording is started. Therefore, if the recorders are not registered each other, it is not possible to realize the takeover of the voice recording by another recorder, or obtain all of the content to be recorded.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 shows an example of a structure of a system of an embodiment.

FIG. 2 shows an operation example of the system shown in FIG. 1.

FIG. 3 is a block diagram showing a structure of each digital voice recording apparatus shown in FIG. 1.

FIG. 4 is a block diagram showing a structure of a server shown in FIG. 1.

FIG. 5 is a block diagram showing a structure of a recording file management application.

FIG. 6 is shown for explaining a determination process by a determination processor.

FIG. 7 shows a case where determination results by the determination processor do not agree with each other.

FIG. 8 shows a case where the determination results by the determination processor agree with each other by changing a threshold value.

FIG. 9 is shown for explaining a determination process by the determination processor.

FIG. 10 is shown for explaining a determination process by the determination processor.

FIG. 11 is shown for explaining a determination process by the determination processor.

FIG. 12 is a flowchart showing an example of steps from specification of a recording file to transmission of the recording file.

FIG. 13 is a block diagram showing a structure of the recording file management application configured to cut out a part of a recording file and combining the cut recording file.

FIG. 14 is a flowchart showing an example of steps for cutting out a part of a recording file and combining the cut file with another recording file.

FIG. 15 is shown for explaining combination of two recording files.

### DETAILED DESCRIPTION

Various embodiments will be described hereinafter with reference to the accompanying drawings. In general, according to one embodiment, an electronic apparatus comprises a memory and a processing circuitry. Each of plurality of recording files comprises positional information indicative of a recording place and time information indicative of recording time and date. The plurality of recording files are prepared by a plurality of recording apparatuses. The processing circuitry searches from a plurality of recording files comprising a first recording file, for a second recording file corresponding to the first recording file, wherein based on the positional information and the time information associated with each of the plurality of recording files, determines whether recorded content of the second recording file comprises at least a part of recorded content of the first recording file, and transmits a third recording file comprising at least a part of the second recording file to a first recording apparatus when the it is determined that the recorded content of the second recording file comprises at least a part of the recorded content of the first recording file.

a search processor, a determination processor, and a transmission processor.

The search processor is configured to search for a second recording file corresponding to a specified first recording file from a plurality of recording files, which contain positional information indicating a recording place and time information indicating recording time and date in association with each other and are prepared by a plurality of recording apparatuses, based on the positional information and the time information associated with each of the plurality of recording files. The determination processor is configured to determine whether recorded content of the second recording file contains at least a part of recorded content of the first recording file. The transmission processor is configured to transmit a third recording file containing at least a part of the second recording file to a first recording apparatus when the determination processor determines that the recorded content of the second recording file contains at least a part of the recorded content of the first recording file.

FIG. 1 shows a system of an embodiment of the present invention.

This system comprises a server computer 10 and a plurality of digital voice recording apparatuses 20 (20A, 20B and 20C).

Each digital voice recording apparatus 20 records the same spoken content and generates a recording file. Each digital voice recording apparatus 20 uploads the recording file and metadata including positional information indicating a recording position and time information indicating a recording time and date to the server 10. The metadata may be additionally written in the recording file.

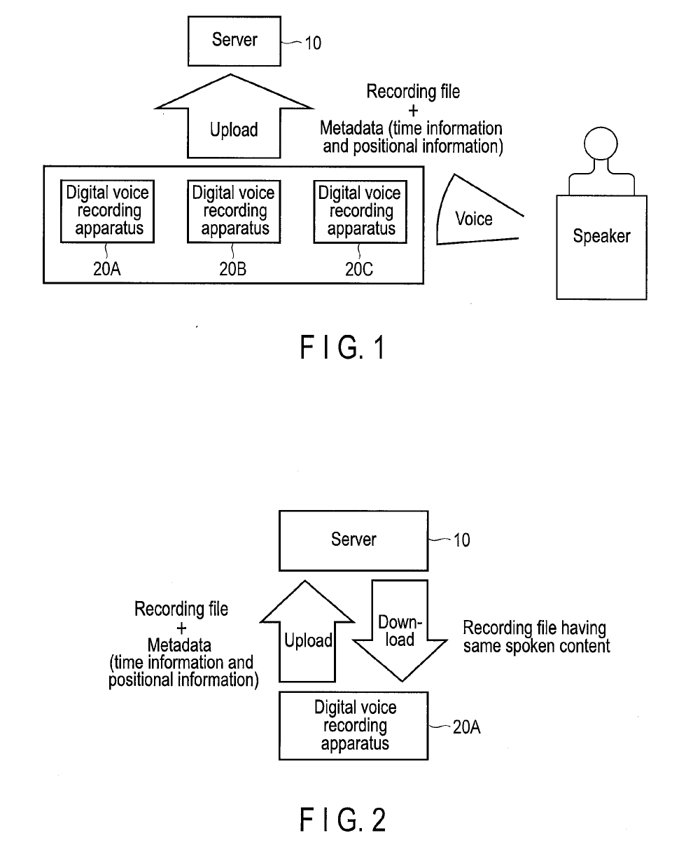

For example, when a user needs voice having high recording quality relative to the recorded voice for certain reasons, the server is queried as to whether or not there is a recording file uploaded by another user. For example, the server 10 searches for a recording file recorded at the substantially same position and the substantially same time and date as the recording file uploaded by the digital voice recording apparatus 20A based on the positional information and time information included in the metadata corresponding to the recording file uploaded by the digital voice recording apparatus 20A. When such a recording file is detected, the server 10 notifies the digital voice recording apparatus 20A that there is the recording file. As shown in FIG. 2, the digital voice recording apparatus 20A downloads the recording file from the server 10.

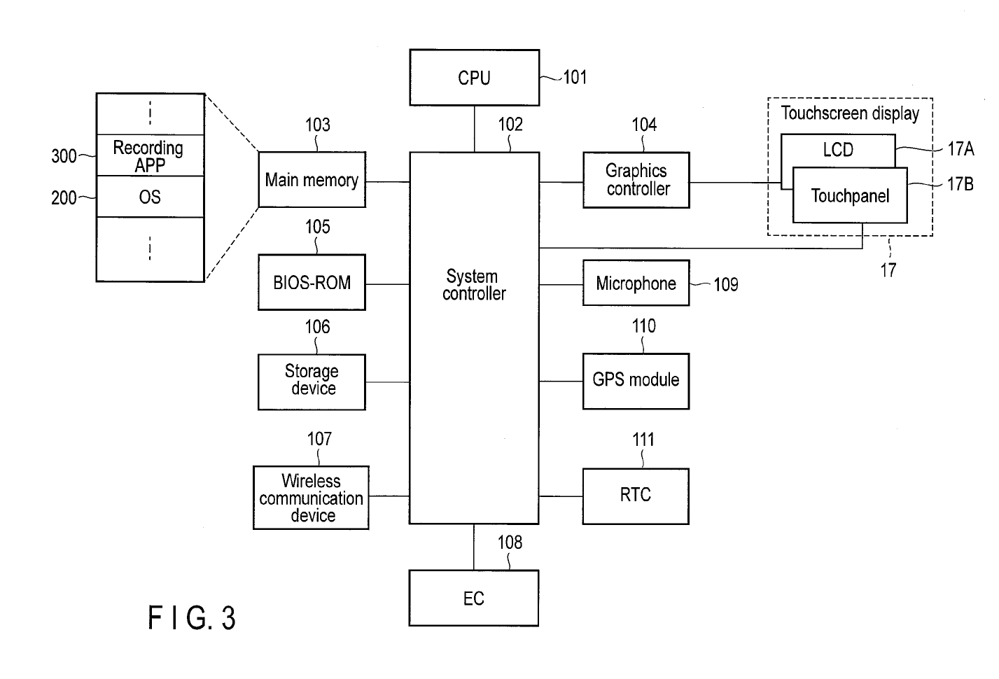

FIG. 3 is a block diagram showing a structure of each digital voice recording apparatus 20. As shown in FIG. 3, each digital voice recording apparatus 20 comprises a touchscreen display 17, a CPU 101, a system controller 102, a main memory 103, a graphics controller 104, a BIOS-ROM 105, a storage device 106, a wireless communication device 107, an embedded controller (EC) 108, a microphone 109, a GPS module 110 and a real time clock (RTC) 111, etc.

The CPU 101 is a processor configured to control the operations of various modules of each digital voice recording apparatus 20. The CPU 101 executes various types of software loaded from the storage device 106 which is a storage device into the main memory 103 which is a volatile memory. The software includes an operating system (OS) 200 and various types of application programs. The application programs include a recording application (recording APP) 300.

The CPU 101 also executes a basic input/output system (BIOS) stored in the BIOS-ROM 105. The BIOS is a program for hardware control.

The system controller 102 is a device configured to connect the local bus of the CPU 101 to various components. In the system controller 102, a memory controller configured to control the access to the main memory 103 is also housed. The system controller 102 is further configured to communicate with the graphics controller 104 through a serial bus conforming to the PCI EXPRESS standard, etc.

The graphics controller 104 is a display controller configured to control an LCD 17A used as the display monitor of each digital voice recording apparatus 20. Display signals generated by the graphic controller 104 are sent to the LCD 17A. The LCD 17A displays a screen image based on the display signals. A touchpanel 17B is provided on the LCD 17A. The touchpanel 17B is a capacitive pointing device for inputting data on the screen of the LCD 17A. A contact position of a finger on the screen and the movement of the contact position, etc., are detected by the touchpanel 17B.

The wireless communication device 107 is a device configured to execute wireless communication by means of a wireless LAN or 3G mobile communication, etc. The EC 108 is a one-chip microcomputer comprising an embedded controller for power management. The EC 108 is configured to turn each digital voice recording apparatus 20 on or off in response to the operation of a power button by a user.

The GPS module 110 measures the position of each digital voice recording apparatus 20. The RTC 111 obtains the time and date.

The recording application 300 compresses and codes the voice collected by the microphone. The recording application 300 additionally writes the positional information indicating the position measured by the GPS module 110 and the time information indicating the time and date obtained by the RTC 111 as metadata in the recording file. The recording application 300 transmits the compressed-and-coded recording file to the server by means of the wireless communication device 107.

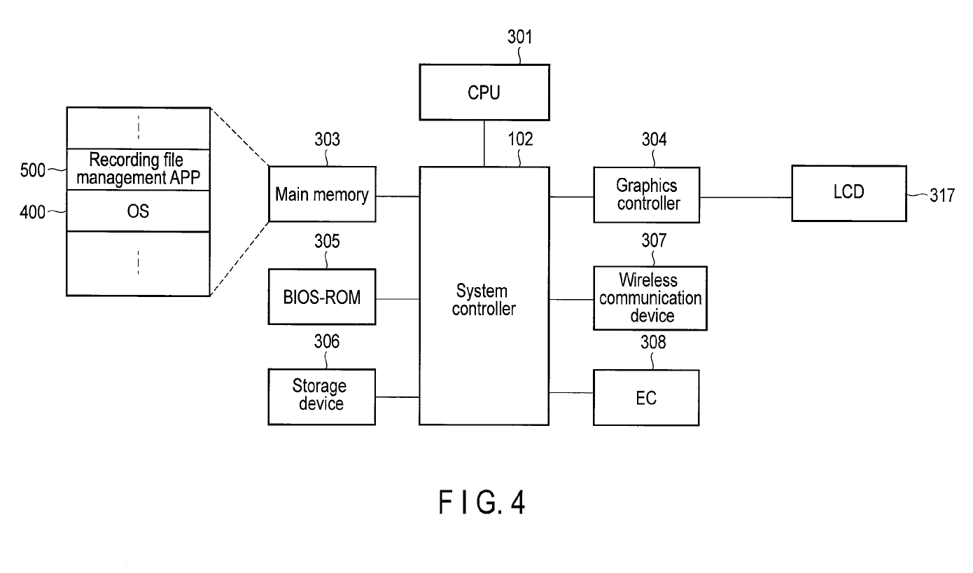

FIG. 4 is a block diagram showing a structure of the server 10.

As shown in FIG. 4, the server 10 comprises a CPU 301, a system controller 302, a main memory 303, a graphics controller 304, a BIOS-ROM 305, a storage device 306, a network controller 307 and an embedded controller (EC) 308, etc.

The CPU 301 is a processor configured to control the operations of various modules of the server 10. The CPU 301 executes various types of software loaded from the storage device 306 into the main memory 303 which is a volatile memory. The software includes an operating system (OS) 400 and various types of application programs. The application programs include a recording file management application (recording file management APP) 500.

Moreover, the CPU 301 executes a basic input/output system (BIOS) stored in the BIOS-ROM 305. The BIOS is a program for hardware control.

The system controller 302 is a device configured to connect the local bus of the CPU 301 to various components. In the system controller 302, a memory controller configured to control the access to the main memory 303 is also housed. The system controller 302 is further configured to communicate with the graphics controller 304 through a serial bus conforming to the PCI EXPRESS standard.

The graphics controller 304 is a display controller configured to control an LCD 317 used as the display monitor of the server 10. Display signals generated by the graphics controller 304 are sent to the LCD 317. The LCD 317 displays a screen image based on the display signals.

The network controller 307 is a device configured to communicate with each digital voice recording apparatus 20 via a network. The EC 308 is a one-chip microcomputer comprising an embedded controller for power management. The EC 308 is configured to turn the server 10 on or off in response to the operation of a power button by a user.

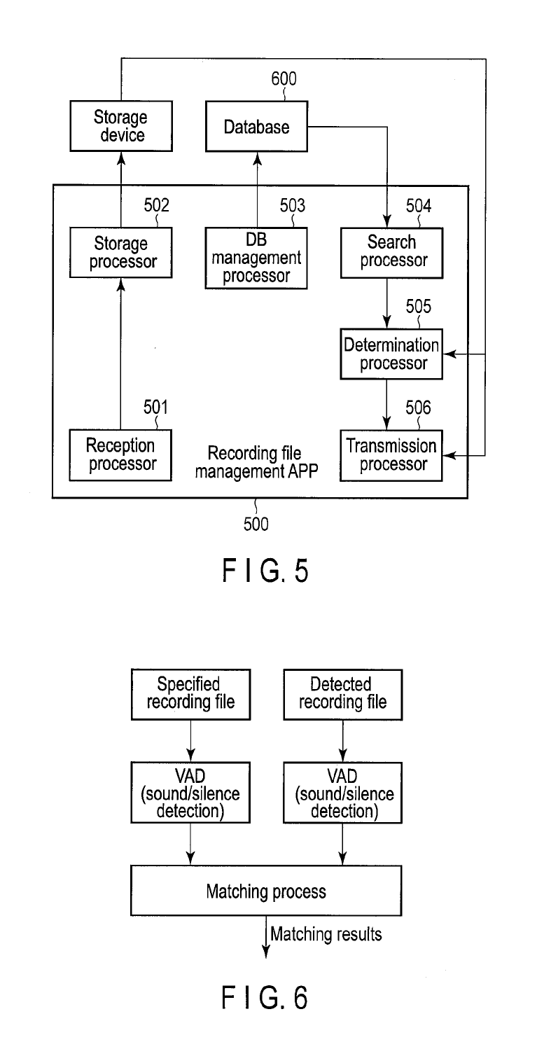

FIG. 5 is a block diagram showing a structure of the recoding file management application 500.

The recording file management application 500 comprises a reception processor 501, a storage processor 502, a database management processor (DB management processor) 503, a search processor 504, a determination processor 505 and a transmission processor 506, etc.

The reception processor 501 receives a recording file uploaded from each digital voice recording apparatus 20. The storage processor 502 stores the received recording file in the storage device 306. The database management processor 503 stores, in a database 600, data in which the storage position of the storage device 306 of the stored recording file, the recording position of the recording file based on the positional information of the metadata, and the recording time and date of the recording file based on the time information of the metadata are associated with each other.

When each digital voice recording apparatus inquires of the server 10 whether or not there is a recording file corresponding to the specified recording file from the uploaded recording files, the search processor 504 searches for a recording file corresponding to the specified recording file from the recording files stored in the storage device based on the recording position and the recording time and date of the specified recording file and the database 600. A recording file corresponding to the specified recording file is a recording file recorded at the substantially same position and the substantially same time and date as the specified recording file.

When a recording file corresponding to the specified recording file is detected, the determination processor 505 determines whether or not the recorded content of the detected recording file includes at least a part of the recorded content of the specified recording file. When the recorded content of the detected recording file is determined as including at least a part of the recorded content of the specified recording file, the transmission processor 506 notifies the digital voice recording apparatus 20 which made the inquiry that there is a recording file corresponding to the specified recording file. When there is a download request from the digital voice recording apparatus 20, the transmission processor 506 transmits the recording file to the digital voice recording apparatus. The detected recording file may be transmitted to the digital voice recording apparatus without the determination process of the determination processor 505.

Now, the determination process of the determination processor 505 is explained. Even if a recording file recorded in the same place at the same time is detected, the detected recording file might contain the spoken content of a lecture conducted on a different floor of the building. Therefore, even if a recording file recorded in the same place at the same time is detected, there is a possibility that the recording file cannot be easily specified as a recording file containing the same spoken content.

For the above reason, it is necessary to determine whether or not the detected recording file contains the same spoken content. The determination regarding whether or not the detected recording file contains the same spoken content can be realized by comparing the specified recording file and the detected recording file in terms of the mutual correlation at a signal level. However, even if the spoken content is the same, the comparison results might not agree with each other because the recording environments are different. Further, when the time of the recorded recording file is long, there is a risk that huge amounts of time are required for the matching process.

First, in order to determine whether or not the spoken content is the same even if the recording environments are different, as shown in FIG. 6, the determination processor 505 performs determination relative to the results of, for example, the voice activity detection (VAD) or sound/silence detection for each certain voice zone (frame) of the specified recording file and the detected recording file. Then, the determination processor 505 performs a matching process of determining whether or not two determination results agree with each other for each voice zone. The determination processor 505 may perform the matching process by calculating and using the feature amount of frequency regions (for example, a formant frequency) as well as the feature amount of time regions. In this manner, it is possible to perform the determination regardless of some noise.

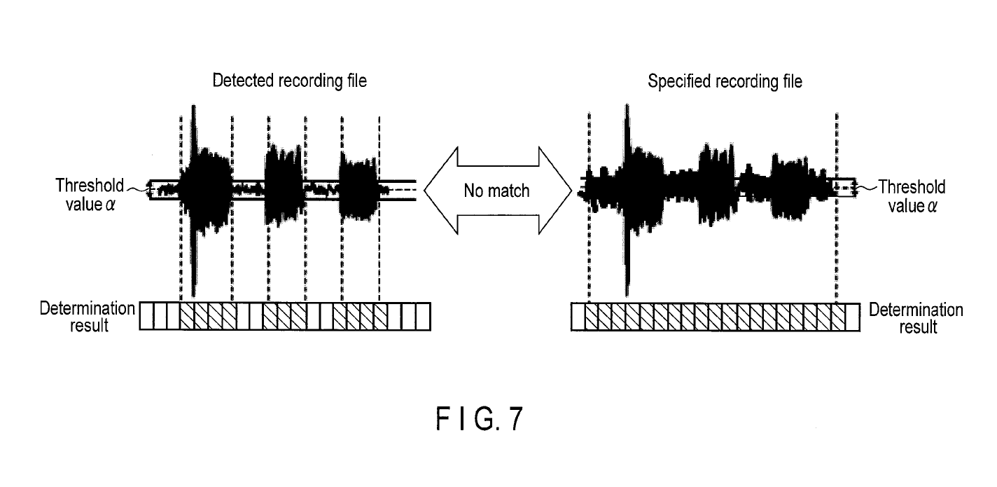

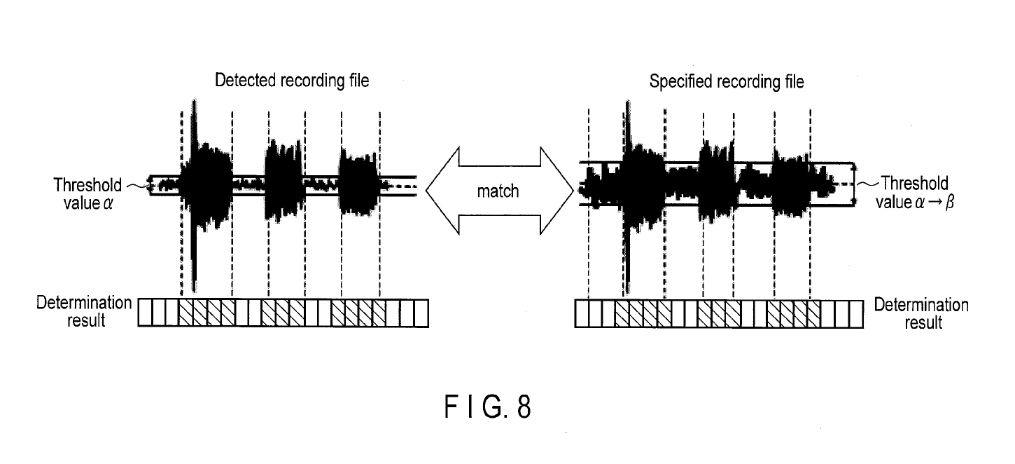

In the above process, when there is a noise source such as a fan near the recording device, as shown in FIG. 7, the determination results sometimes do not agree with each other. The threshold value at the time of performing VAD or sound/silence detection is changed. As shown in FIG. 8, when the determination results agree with each other after the change of the threshold value, the recording files are determined as containing the same spoken content.

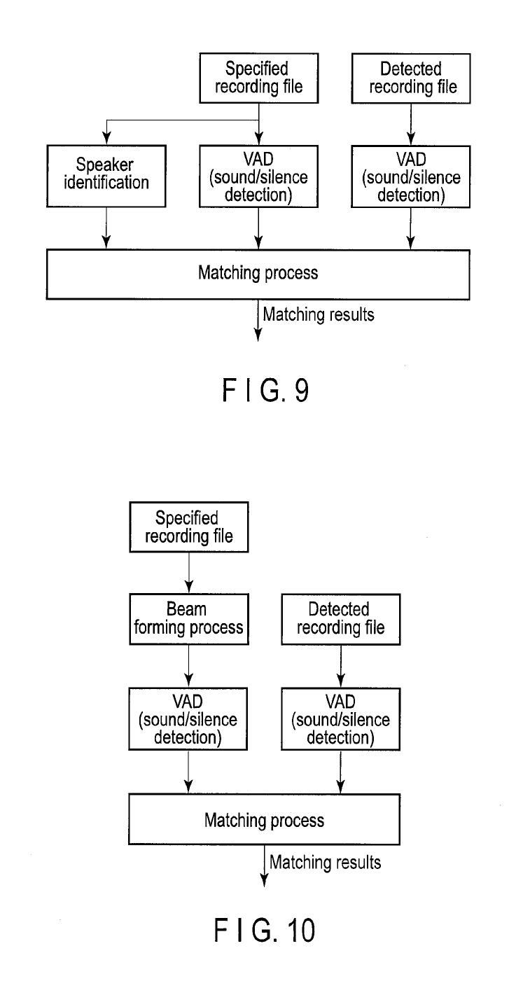

When there is another speaker near the recording device, the determination results may not agree with each other. As shown in FIG. 9, the determination processor 505 performs speaker identification for each certain voice zone (frame) of the specified recording file. When the results of VAD or sound/silence detection of even one speaker agree with each other, the determination processor 505 may determine that the spoken content is the same.

When sound is recorded by two directional microphones, as shown in FIG. 10, the determination processor 505 emphasizes the voice generated from a particular and arbitrary angle by applying a beam forming process to the specified recording file instead of applying speaker identification. When the result of VAD or sound/silence detection performed for the emphasized voice agrees with the result of VAD or sound/silence detection performed for the detected recording file, the determination processor 505 may determine that the spoken content is the same voice.

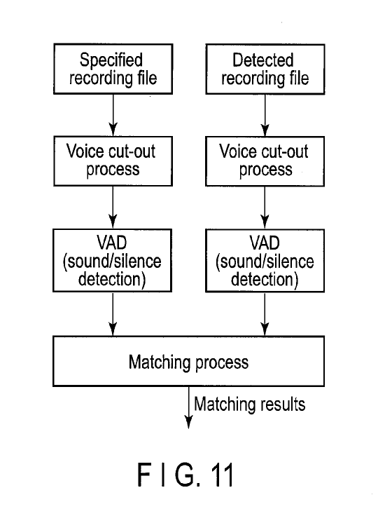

On the other hand, in order not to take huge amounts of time for the process, as shown in FIG. 11, the determination processor 505 may perform the matching process after a part of voice is cut out from each of the specified recording file and the detected recording file. By adjusting the file size of the cut voice so as not to change even when the recording time is long, the matching processing time becomes constant regardless of the recording time. As a method for easily cutting out voice, voice may be uniquely cut out for each intermittent zone depending on the time information.

If a recording file having the same spoken content can be detected as a result of the matching determination explained above, it is possible to listen to a recording file of another user depending on the request of a user without an annoying operation related to the takeover of the recording. Specifically, it is possible to listen to clear voice with the best SNR and listen to the entire content from the beginning to the end of a lecture or a meeting.

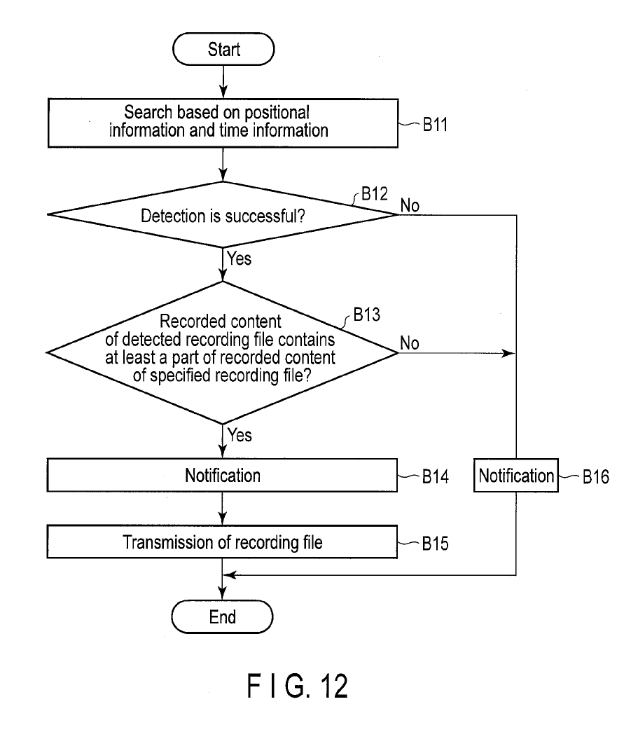

Next, this specification explains steps from the specification of a recording file to the transmission of the recording file with reference to FIG. 12. FIG. 12 is a flowchart showing an example of the steps from the specification of a recording file to the transmission of the recording file.

The determination processor 505 searches for a recording file corresponding to the specified recording file from a plurality of recording files stored in the storage device 106 based on the positional information and the time information associated with the specified recording file (block B11). The search processor 504 determines whether or not a recording file corresponding to the specified recording file is successfully detected (block B12). When the detection is successful (Yes in block B12), the determination processor 505 determines whether or not the recorded content of the detected recording file contains at least a part of the recorded content of the specified recording file (block B13). When the recorded content of the detected recording file is determined as containing at least a part of the recorded content of the specified recording file (Yes in block B13), the determination processor 505 notifies the digital voice recording apparatus that there is a recording file corresponding to the specified recording file (block B14). When there is a download request from the digital voice recording apparatus, the transmission processor 506 transmits the detected recording file to the digital voice recording apparatus 20 (block B15). When the detection is unsuccessful (No in block B12), or the recorded content of the detected recording file is determined as not containing at least a part of the recorded content of the specified recording file (No in block B13), the detection processor 504 notifies the digital voice recording apparatus that there is no recording file corresponding to the specified recording file (block B16).

When there are a plurality of recording files having the same spoken content on the server, each of the voice files may be cut out and combined with each other so as to listen to recording voice with good recording quality from the beginning to the end.

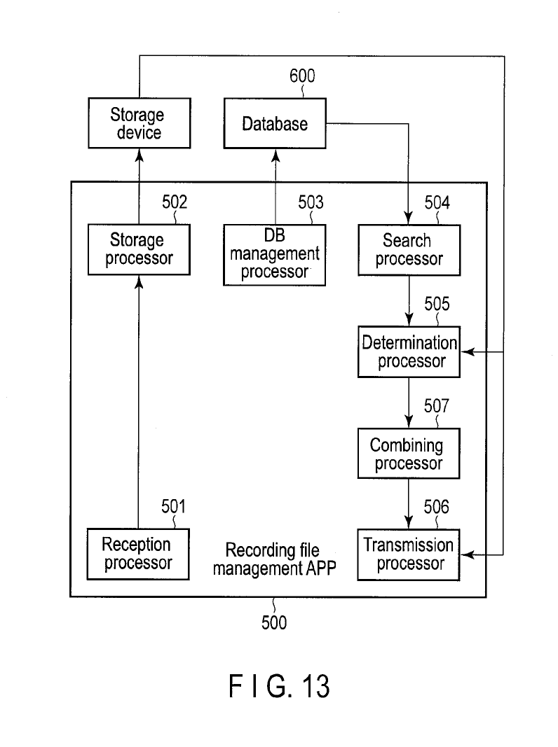

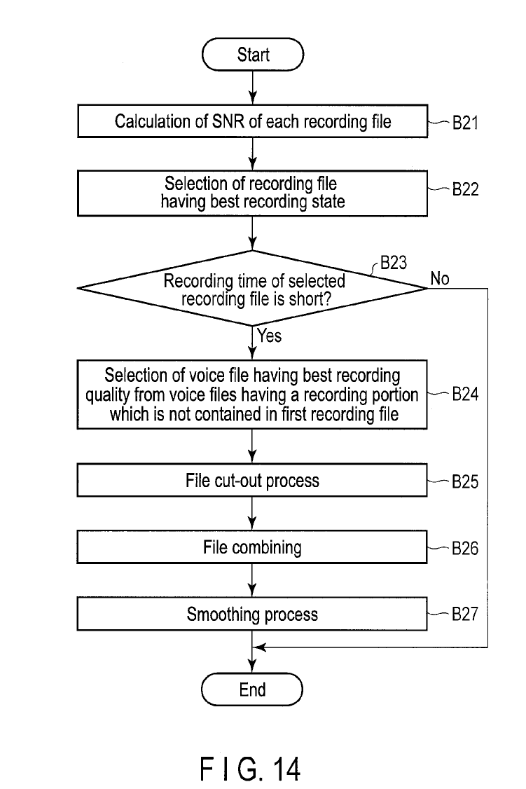

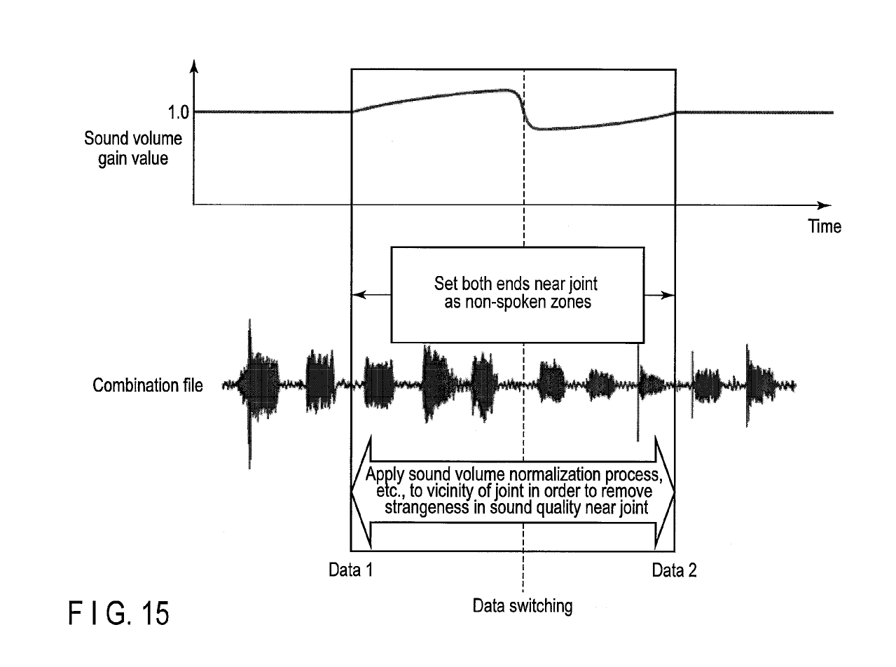

Now, this specification explains an example of cutting out a part of a recording file in the server 10 and combining the cut recording file with reference to FIG. 13, FIG. 14 and FIG. 15.

FIG. 13 is a block diagram showing a structure of the recording file management application 500 configured to cut out a part of a recording file and combine the cut recording file.

The recording file management application 500 further comprises a combining processor 507. The combining processor 507 cuts out a part of a recording file and combines the cut recording file.

FIG. 14 is a flowchart showing an example of steps for cutting out a part of a recording file and combining the cut recording file with another recording file.

The combining processor 507 calculates the signal-noise ratio (SNR) of each of the detected recording files (block B21). The combining processor 507 selects a recording file having the best recording state based on the calculated SNR (block B22). After that, the combining processor 507 determines whether or not the recording time of the selected recording file (hereinafter, referred to as the first recording file) is shorter than the recording time of the other recording files (block B23). When the combining processor 507 determines that the recording time of the first recording file is shorter (Yes in block B23), the combining processor 507 selects a recording file (hereinafter, referred to as the second recording file) having the best recording state based on the calculated SNR from recording files having recording time which is longer than the first recording file (block B24). The combining processor 507 cuts out the insufficient portion of the first recording file from the second recording file (block B25). The combining processor 507 combines the first recording file and the cut recording file (block B26). When combining the files, by using a silent portion for the connection point in such a way that the vibration amplitude is as close to zero as possible as shown in FIG. 15, the difference in sound quality in the connection portion is small. When the noise or sound volume is different between the before and after the connection portion, a smoothing process such as a noise cancelling process or sound volume normalization process is applied in order to obtain the same quality (block B27).

It is possible to provide a recording file containing content desired by a user by searching for a recording file corresponding to the specified recording file based on the positional information and the time information associated with the specified recording file from a plurality of recording files stored in the storage device and transmitting a recording file containing at least a part of the detected recording file.

Various processes of the embodiments described herein can be realized by a computer program. Therefore, the same effect as the embodiments can be easily obtained by only installing the computer program in a normal computer through a computer-readable memory medium in which the program is stored and executing the program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a memory; and
a processing circuitry
to search from a plurality of recording files comprising a first recording file, for a second recording file corresponding to the first recording file, wherein each of the plurality of recording files comprises positional information indicative of a recording place and time information indicative of recording time and date, and the plurality of recording files are prepared by a plurality of recording apparatuses, based on the positional information and the time information associated with each of the plurality of recording files,
to determine whether recorded content of the second recording file comprises at least a part of recorded content of the first recording file, and
to transmit a third recording file comprising at least a part of the second recording file to a first recording apparatus when the it is determined that the recorded content of the second recording file comprises at least a part of the recorded content of the first recording file.

2. The apparatus of claim 1, wherein
the processing circuitry performs voice activity detection or sound/silence detection for a voice zone of each of the first recording file and the second recording file, and determines whether the recorded content of the second recording file comprises at least a part of the recorded content of the first recording file based on determination results of the voice activity detection or the sound/silence detection.

3. The apparatus of claim 2, wherein the processing circuitry:
performs speaker identification for the voice zone of the first recording file; and
determines that the recorded content of the second recording file comprises at least a part of the recorded content of the first recording file when results of the voice activity detection or the sound/silence detection of one of identified speakers from each of the first and second recording files agree with each other.

4. The apparatus of claim 2, wherein
the voice activity detection or the sound/silence detection is performed for a fourth recording file comprising a part of the first recording file and a fifth recording file comprising the second recording file.

5. The apparatus of claim 1, wherein
when a sixth recording file corresponding to the first recording file is further detected from the plurality of recording files, the processing circuitry transmits one of the second recording file and the sixth recording file having higher recording quality than the other to the first recording apparatus.

6. The apparatus of claim 5, the processing circuitry cuts out a seventh recording file comprising recorded content which is not contained in the recorded content of the second recording file from the sixth recording file and combine the second recording file with the seventh recoding file when recording quality of the second recording file is higher than recording quality of the sixth recording file and recorded content of the sixth recording file comprises the recorded content which is not included in the recorded content of the second recording file.

7. The apparatus of claim 1, wherein sound content of the third recording file comprises all of voice content of the second recording file.

8. A recording file transmission method using an electronic apparatus comprising:
searching from a plurality of recording files comprising a first recording file, for a second recording file related to the first recording file, each of the plurality of recording files comprises positional information indicative of a recording place and time information indicative of recording time and date, and the plurality of recording files are prepared by a plurality of recording apparatuses, based on the positional information and the time information associated with each of the plurality of recording files;
determining whether recorded content of the second recording file comprises at least a part of recorded content of the first recording file; and
transmitting a third recording file comprising at least a part of the second recording file to a first recording apparatus when the recorded content of the second recording file comprises at least a part of the recorded content of the first recording file.

9. A computer readable, non transitory storage medium to store a computer program which is executable by a computer, the computer program controlling the computer to execute functions of:
searching from a plurality of recording files comprising a first recording file, for a second recording file corresponding to the first recording file, each of the plurality of recording files comprise positional information indicative of a recording place and time information indicative of recording time and date and the plurality of recording files are prepared by a plurality of recording apparatuses, based on the positional information and the time information associated with each of the plurality of recording files;
determining whether recorded content of the second recording file comprises at least a part of recorded content of the first recording file; and
transmitting a third recording file comprising at least a part of the second recording file to a first recording apparatus when the recorded content of the second recording file is determined as comprising at least a part of the recorded content of the first recording file.
